(19) United States
(12) Patent Application Publication
(10) Pub. No.: US 2004/0136602 A1
(43) Pub. Date: Jul. 15, 2004

(54) Method and apparatus for performing non-dyadic wavelet transforms

(76) Inventors: Nithin Nagaraj, Karnataka (IN); Sudipta Mukhopadhyay, Bangalore (IN); Frederick Wilson Wheeler, Niskayuna, NY (US)

Correspondence Address: Patrick S. Yoder, Fletcher, Yoder & Van Someren, P.O. Box 692289, Houston, TX, 77269-2289, US

(21) Appl. No.: 10/340,093

(22) Filed: Jan. 10, 2003

(51) Int. Cl. G06K 9/36

(52) U.S. Cl. 382/240

(57) ABSTRACT

A technique for compressing data using non-dyadic wavelet transforms. The non-dyadic wavelet transforms may be derived from a generalized model or specific non-dyadic wavelet transforms may be constructed as needed to enhance the desired image qualities in a compressed image. The non-dyadic wavelet transforms may be differentially applied to different data dimensions to accommodate non-square transformations. In addition, the non-dyadic wavelet transforms can be cascaded to achieve novel image resolutions in the compressed images.

### BACKGROUND OF THE INVENTION

The present invention relates generally to the field of image data compression. More particularly, the invention relates to a technique for compressing image data for rapid transmission and decompression.

A wide range of applications exist for image data compression. Digitized images may be created in a variety of manners, such as via relatively simple digitizing equipment and digital cameras, as well as by complex imaging systems, such as those used in medical diagnostic applications. Regardless of the environment in which the image data originates, the digital data descriptive of the images is stored for later reconstruction and display, and may be transmitted to various locations by networks, such as the Internet. Goals in digital image management include the efficient use of memory allocated for storage of the image data, as well as the efficient and rapid transmission of the image data for reconstruction. The latter goal is particularly important where large or complex images are to be handled over comparatively limited bandwidth networks. In the medical diagnostic imaging field, for example, very large image data sets may be available for transmission and viewing by a range of users, including those having limited access to very high bandwidths needed for rapid transmission of full detail images.

Picture archiving and communication systems, or PACS, have become an extremely important component in the management of digitized image data, particularly in the field of medical imaging. Such systems often function as central repositories of image data, receiving the data from various sources, such as medical imaging systems. The image data is stored and made available to radiologists, diagnosing and referring physicians, and other specialists via network links. Improvements in PACS have led to dramatic advances in the volumes of image data available, and have facilitated loading and transferring of voluminous data files both within institutions and between the central storage location or locations and remote clients.

A major challenge to further improvements in all image handling systems, from simple Internet browsers to PACS in medical diagnostic applications, is the handling of the large data files defining images. In the medical diagnostics field, depending upon the imaging modality, digitized data may be acquired and processed for a substantial number of images in a single examination, each image representing a large data set defining discrete picture elements or pixels of a reconstructed image. Computed Tomography (CT) imaging systems, for example, can produce numerous separate images along an anatomy of interest in a very short examination timeframe. Ideally, all such images are stored centrally on the PACS, and made available to the radiologist for review and diagnosis.

Various techniques have been proposed and are currently in use for analyzing and compressing large data files, such as medical image data files. Image data files typically include streams of data descriptive of image characteristics, typically of intensities or other characteristics of individual pixels in the reconstructed image. In the medical diagnostic field, these image files are typically created during an image acquisition or encoding sequence, such as in an X-ray system, a magnetic resonance imaging system, a computed tomography imaging system, and so forth. The image data is then processed, such as to adjust dynamic ranges, or to enhance certain features shown in the image, for storage, transmittal and display.

While image files may be stored in raw and processed formats, many image files are quite large, and would occupy considerable disc or storage space. The increasing complexity of imaging systems also has led to the creation of very large image files, typically including more data as a result of the useful dynamic range of the imaging system, the size of the matrix of image pixels, and the number of images acquired per examination.

In addition to occupying large segments of available memory, large image files can be difficult or time consuming to transmit from one location to another. In a typical medical imaging application, for example, a scanner or other imaging device will typically create raw data which may be at least partially processed at the scanner. The data is then transmitted to other image processing circuitry, typically including a programmed computer, where the image data is further processed and enhanced. Ultimately, the image data is stored either locally at the system, or in the PACS for later retrieval and analysis. In all of these data transmission steps, the large image data file must be accessed and transmitted from one device to another.

Current image handling techniques include compression of image data within the PACS environment to reduce the storage requirements and transmission times. One drawback of existing compression techniques is the storage, access and transmission of large data files even when a user cannot or does not desire to view the reconstructed image in all available detail. For example, in medical imaging, extremely detailed images may be acquired and stored, while a radiologist or physician who desires to view the images may not have a view port capable of displaying the image in the resolution in which they are stored. Thus, transmission of the entire images to a remote viewing station, in relatively time consuming operations, may not provide any real benefit and may slow reading or other use of the images.

Compression schemes that make use of a dyadic wavelet transform address some of these concerns. Compression schemes utilizing dyadic wavelet transforms exploit embedded resolutions within a multi-resolution framework, thereby allowing more flexibility in terms of the image resolutions which are stored or transmitted. Unfortunately, because the dyadic wavelet transforms operate in factors of one half, when applied uniformly to a multi-dimensional data object such as an image, the image resolution is reduced by half in each dimension after each iteration. This limits the number of useful decompositions which can be performed and also results in the aspect ratio, i.e., the ratio of one transformed dimension to the other, such as the height/width, remaining constant after each level of decomposition. In addition, the resolution of the display device may be between levels of decomposition in a dyadic framework, resulting in a displayed image which is not optimized for the display device as well as non-optimal transmission of data in a networked environment. In other words, more or less compressed data than is optimal may be sent to a view station which in turn may not be able to display at the optimal resolution of the display device. These issues generally arise due to the limited flexibility a dyadic wavelet transform provides in terms of the available levels of decomposition.

There is a need, therefore, for an improved image data compression and decompression technique which provides rapid compression and decompression of image files, and which obtains improved compression ratios and transmission times. There is a particular need for a technique which permits compressed image data files to be created and transmitted in various resolutions or sizes, depending upon the bandwidth and desired or available resolution on a client side.

### BRIEF DESCRIPTION OF THE INVENTION

The present techniques provide a novel approach to image compression. In particular, non-dyadic wavelet transforms are employed to increase the perceptible levels of decomposition, thereby increasing the flexibility of the compression techniques. The non-dyadic wavelet transforms may be applied to various dimensions of the data, i.e., height, width, depth, time, including differential application to accommodate non-square compression sets. In addition, the non-dyadic wavelet transforms may be cascaded to produce dyadic or other non-dyadic resolutions or may be applied differentially such that the aspect ratio may be changed after compression.

In accordance with one aspect of the present technique, a method is provided for compressing a set of data points. A plurality of data points are grouped into one or more subgroups. One or more first coefficients are calculated for each subgroup. Each first coefficient is calculated using two or more data points within the respective subgroup. One or more second coefficients are calculated for each subgroup. Each second coefficient is calculated using at least one of one or more first coefficients and one or more data points within the respective subgroup. The number of first coefficients does not equal the number of second coefficients.

In accordance with another aspect of the present technique, a codec is provided for compressing and decompressing digital data. The codec includes a coder configured to group a plurality of data points comprising a digital record into one or more subgroups. The coder is also configured to calculate one or more first coefficients for each subgroup. Each first coefficient is calculated using two or more data points within the respective subgroup. The coder is also configured to calculate one or more second coefficients for each subgroup. Each second coefficient is calculated using at least one of one or more first coefficients and one or more data points within the respective subgroup. The number of first coefficients does not equal the number of second coefficients. The codec also includes a decoder configured to reconstruct the plurality of data points from the first coefficients and the second coefficients.

In accordance with an additional aspect of the present technique, an image management system is provided. The system includes one or more file servers configured to receive one or more data files from and to transmit one or more data files to at least one of one or more input/output interface, one or more imaging systems, one or more image storage systems, and one or more remote clients. The system also includes a codec configured to process the data files. The codec includes a coder configured to group a plurality of data points comprising a digital record into one or more subgroups. The coder is also configured to calculate one or more first coefficients for each subgroup. Each first coefficient is calculated using two or more data points within the respective subgroup. The coder is also configured to calculate one or more second coefficients for each subgroup. Each second coefficient is calculated using at least one of one or more first coefficients and one or more data points within the respective subgroup. The number of first coefficients does not equal the number of second coefficients. The codec also includes a decoder configured to reconstruct the plurality of data points from the first coefficients and the second coefficients.

In accordance with another aspect of the present technique, a tangible medium is provided for compressing a set of data points. The tangible medium includes a routine for grouping a plurality of data points into one or more subgroups. In addition, the tangible medium includes a routine for calculating one or more first coefficients for each subgroup. Each first coefficient is calculated using two or more data points within the respective subgroup. The tangible medium also includes a routine for calculating one or more second coefficients for each subgroup. Each second coefficient is calculated using at least one of one or more first coefficients and one or more data points within the respective subgroup. The number of first coefficients does not equal the number of second coefficients.

In accordance with an additional aspect of the present technique, a method is provided for compressing a set of data points. A set of data points is accessed. A non-dyadic wavelet transform is applied to the set of data points such that a first set of transformed data and a second set of transformed data result.

In accordance with another aspect of the present technique, codec is provided for compressing and decompressing digital data. The codec includes a coder configured to access a set of data points and to apply a non-dyadic wavelet transform to the set of data points such that a first set of transformed data and a second set of transformed data result. The codec also includes a decoder configured to apply an inverse non-dyadic wavelet transform to the first set of transformed data and the second set of transformed data such that the set of data points is reconstructed.

In accordance with another aspect of the present technique, an image management system is provided. The system includes one or more file servers configured to receive one or more data files from and to transmit one or more data files to at least one of one or more input/output interface, one or more imaging systems, one or more image storage systems, and one or more remote clients. The system also includes a codec configured to process the data files. The codec includes a coder configured to access a set of data points and to apply a non-dyadic wavelet transform to the set of data points such that a first set of transformed data and a second set of transformed data result. The codec also includes a decoder configured to apply an inverse non-dyadic wavelet transform to the first set of transformed data and the second set of transformed data such that the set of data points is reconstructed.

In accordance with another aspect of the present technique, an image management system is provided. The system includes one or more file servers configured to receive one or more data files from and to transmit one or more data files to at least one of one or more input/output interface, one or more imaging systems, one or more image storage systems, and one or more remote clients. The system also includes means for performing one or more non-dyadic transformations on the data files.

In accordance with an additional aspect of the present technique, a tangible medium is provided for compressing a set of data points. The tangible medium includes a routine for accessing a set of data points. The tangible medium also includes a routine for applying a non-dyadic wavelet transform to the set of data points such that a first set of transformed data and a second set of transformed data result.

In accordance with another aspect of the present technique, a method is provided for decompressing a set of data points. A first set of transformed data points and a second set of transformed data points is accessed. An inverse non-dyadic wavelet transform is applied to the first set of transformed data points and the second set of transformed data points such that an untransformed set of data points results.

### BRIEF DESCRIPTION OF THE DRAWINGS

The foregoing and other advantages and features of the invention will become apparent upon reading the following detailed description and upon reference to the drawings in which:

FIG. 1 is a diagrammatical representation of an exemplary image management system, in the illustrated example a picture archiving and communication system or PACS, for receiving and storing image data in accordance with certain aspects of the present technique;

FIG. 2 is a diagrammatical representation of contents of a database for referencing stored image data in files containing multiple image data sets, compressed data, and descriptive information;

FIG. 3 is a representation of a typical image of the type received, compressed, and stored on the system of FIG. 1;

FIG. 4 is a state diagram of a subset of data undergoing a generalized non-dyadic forward transform;

FIG. 5 is a state diagram of a generalized non-dyadic forward transform;

FIG. 6 is a state diagram of the result set of FIG. 4 undergoing a further generalized non-dyadic forward transform;

FIG. 7 is a representation of the frequency subbands generated via non-dyadic forward transform through multiple levels of decomposition;

FIG. 8 is a state diagram of a generalized non-dyadic inverse transform corresponding to the generalized non-dyadic forward transform of FIG. 5;

FIG. 9 is a diagrammatical representation of an exemplary codec configured to implement non-dyadic wavelet transforms;

FIG. 10 is a state diagram of a subset of data undergoing a specific non-dyadic forward transform;

FIG. 11 is a state diagram of a specific non-dyadic inverse transform corresponding to the specific non-dyadic forward transform of FIG. 10;

FIG. 12 is a state diagram of a subset of data undergoing an alternative specific non-dyadic forward transform; and

FIG. 13 is a state diagram of a specific non-dyadic inverse transform corresponding to the specific non-dyadic forward transform of FIG. 12.

### DETAILED DESCRIPTION OF SPECIFIC EMBODIMENTS

The techniques discussed below relate to data coding systems in general, particularly systems in which data consisting of sets of data points are coded or compressed for storage, transmission, or display. Data which may be processed in such a manner include digital images, digital video and volume data. Examples of such data include digitally captured images or video, including those associated with security screening, i.e., baggage screening and biometrics, medical imaging, non-destructive materials testing, meteorological data collection, and digital photos and film. In addition, analog images or video which have been converted into a digital format, such as via scanning or some other conversion mechanism, are also examples of such data. Though these various different types of digital data are susceptible to the techniques discussed below, for simplicity the following discussion will be presented in the context of medical imaging. It is to be understood, however, that references to medical images and medical imaging systems is merely intended to be illustrative of the general techniques discussed, and not limiting in scope or breadth.

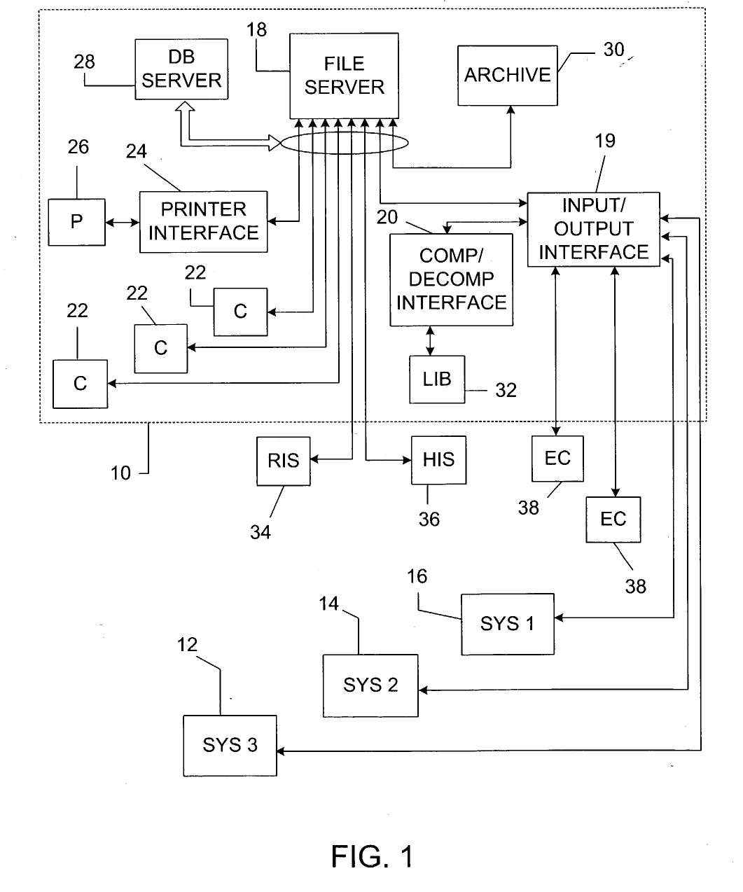

For example, FIG. 1 illustrates an exemplary image data management system in the form of a picture archive and communication system or PACS 10 for receiving, compressing and decompressing image data. In the illustrated embodiment, PACS 10 receives image data from several separate imaging systems designated by reference numerals 12, 14 and 16. As will be appreciated by those skilled in the art, the imaging systems may be of various type and modality, such as magnetic resonance imaging (MRI) systems, computed tomography (CT) systems, positron emission tomography (PET) systems, radio fluoroscopy (RF), computed radiography (CR), ultrasound systems, and so forth. Moreover, the systems may include processing stations or digitizing stations, such as equipment designed to provide digitized image data based upon existing film or hard copy images. It should also be noted that the systems supplying the image data to the PACS may be located locally with respect to the PACS, such as in the same institution or facility, or may be entirely remote from the PACS, such as in an outlying clinic or affiliated institution. In the latter case, the image data may be transmitted via any suitable network link, including open networks, proprietary networks, virtual private networks, and so forth.

PACS 10 includes one or more file servers 18 designed to receive and process image data, and to make the image data available for decompression and review. Server 18 receives the image data through an input/output interface 19. Image data may be compressed in routines accessed through a compression/decompression interface 20. As described more fully below, interface 20 serves to compress the incoming image data rapidly and optimally, while maintaining descriptive image data available for reference by server 18 and other components of the PACS. Where desired, interface 20 may also serve to decompress image data accessed through the server. Compression of the data at the interface 20 may allow more data to be stored on the system 10 or may allow data to be transmitted more rapidly and efficiently to sites on the network which may also be configured to decompress the compressed data.

The server is also coupled to internal clients, as indicated at reference numeral 22, each client typically including a work station at which a radiologist, physician, or clinician may access image data from the server, decompress the image data, and view or output the image data as desired. Clients 22 may also input information, such as dictation of a radiologist following review of examination sequences. Similarly, server 18 may be coupled to one or more interfaces, such as a printer interface 24 designed to access and decompress image data, and to output hard copy images via a printer 26 or other peripheral.

Server 28 may associate image data, and other work flow information within the PACS by reference to one or more file servers 18. In the presently contemplated embodiment, database server 28 may include cross-referenced information regarding specific image sequences, referring or diagnosing physician information, patient information, background information, work list cross-references, and so forth. The information within database server 28 serves to facilitate storage and association of the image data files with one another, and to allow requesting clients to rapidly and accurately access image data files stored within the system. Similarly, server 18 is coupled to one or more archives 30, such as an optical storage system, which serve as repositories of large volumes of image data for backup and archiving purposes. Techniques for transferring image data between server 18, and any memory associated with server 18 forming a short term storage system, and archive 30, may follow any suitable data management scheme, such as to archive image data following review and dictation by a radiologist, or after a sufficient time has lapsed since the receipt or review of the image files.

In the illustrated embodiment, other components of the PACS system or institution may be integrated with the foregoing components to further enhance the system functionality. For example, as illustrated in FIG. 1, a compression/decompression library 32 is coupled to interface 20 and serves to store compression routines, algorithms, look up tables, and so forth, for access by interface 20 (or other system components) upon execution of compression and decompression routines (i.e. to store various routines, software versions, code tables, and so forth). In practice, interface 20 may be part of library 32. Library 32 may also be coupled to other components of the system, such as client stations 22 or printer interface 24, which may also be configured to compress or decompress data, serving similarly as a library or store for the compression and decompression routines and algorithms. Although illustrated as a separate component in FIG. 1, it should be understood that library 32 may be included in any suitable server or memory device, including within server 18. Moreover, code defining the compression and decompression processes described below may be loaded directly into interface 20 and/or library 32, or may be loaded or updated via network links, including wide area networks, open networks, and so forth.

Additional systems may be linked to the PACS, such as directly to server 28, or through interfaces such as interface 19. In the embodiment illustrated in FIG. 1, a radiology department information system or RIS 34 is linked to server 18 to facilitate exchanges of data, typically cross-referencing data within database server 28, and a central or departmental information system or database. Similarly, a hospital information system or HIS 36 may be coupled to server 28 to similarly exchange database information, workflow information, and so forth. Where desired, such systems may be interfaced through data exchange software, or may be partially or fully integrated with the PACS system to provide access to data between the PACS database and radiology department or hospital databases, or to provide a single cross-referencing database. Similarly, external clients, as designated at reference numeral 38, may be interfaced with the PACS to enable images to be viewed at remote locations. Such external clients may employ decompression software, or may receive image files already decompressed by interface 20. Again, links to such external clients may be made through any suitable connection, such as wide area networks, virtual private networks, and so forth.

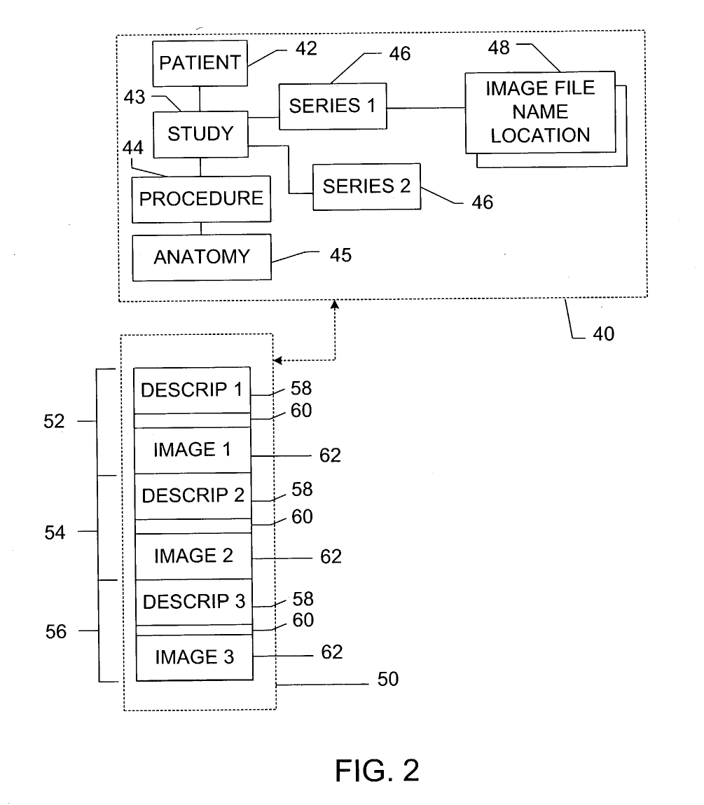

FIG. 2 illustrates in somewhat greater detail the type of cross-referencing data made available to clients 20, 22, 24, 30 through database server 28. The database entries, designated generally by reference numeral 40 in FIG. 2, will include cross-referenced information, including patient data 42, references to specific studies or examinations 43, references to specific procedures performed 44, references to anatomy imaged 45, and further references to specific image series 46 within the study or examination. As will be appreciated by those skilled in the art, such cross-referenced information may include further information regarding the time and date of the examination and series, the name of diagnosing, referring, and other physicians, the hospital or department where the images are created, and so forth. The database will also include address information identifying specific images, file names, and locations of the images as indicated at reference numeral 48. Where the PACS includes various associated memory devices or short term storage systems, these locations may be cross-referenced within the database and may be essentially hidden from the end user, the image files simply being accessed by the system for viewing from the specific storage location based upon cross-referenced information in the database.

As described more fully below, in accordance with certain aspects of the present technique, descriptive information is used to identify preferred or optimal compression routines used to compress image data. Such descriptive information is typically available from header sections of an image data string, also as described in detail below. However, information available from database server 28 may also serve as the basis for certain of the selections of the algorithms employed in the compression technique. Specifically database references may be relied upon for identifying such descriptive information as the procedures performed in an imaging sequence, specific anatomies or other features viewable in reconstructed images based upon the data, and so forth. Such information may also be available from the RIS 34 and from the HIS 36.

FIG. 2 also illustrates an exemplary image file cross-referenced by the database entries. As shown in FIG. 2, image file 50 includes a plurality of image data sets 52, 54 and 56. In a typical image file, a large number of such image sets may be defined by a continuous data stream. Each data set may be compressed in accordance with specific compression algorithms, including the compression algorithms as described below.

Within each image data set, a descriptive header 58 is provided, along with a compression header 60. The headers 58 and 60 are followed by compressed image data 62. The descriptive header 58 of each data set preferably includes industry-standard or recognizable descriptive information, such as DICOM compliant descriptive data. As will be appreciated by those skilled in the art, such descriptive information will typically include an identification of the patient, image, date of the study or series, modality of the system creating the image data, as well as additional information regarding specific anatomies or features visible in the reconstructed images. As described more fully below, such descriptive header data is preferably employed in the present technique for identification of optimal compression algorithms or routines used to compress the data within the compressed image data section 62. Data referring to the specific algorithm or routine used to compress the image data is then stored within compression header 60 for later reference in decompressing the image data. As described below, additional data is stored within the compressed image data, cross-referencing the algorithms identified in compression header 60 for use in decompressing the image data. Specifically, in a presently preferred embodiment, the compression header 60 includes identification of the length of subregions of the compressed image data, as well as references to specific optimal algorithms, in the form of compression code tables used to compress the subregions optimally.

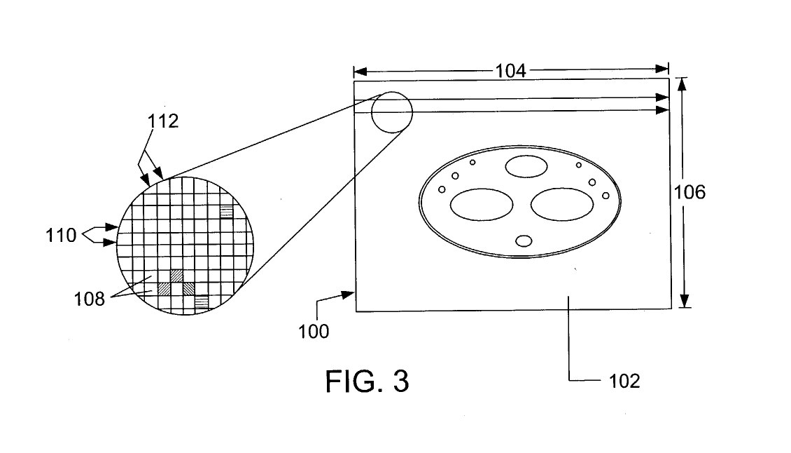

FIG. 3 illustrates an example of data, here illustrated as a digital image which is encoded by packets of digitized data assembled in a continuous data stream which may be compressed and decompressed in the present techniques. The image, designated generally by the reference numeral 100, may include features of interest 102, such as specific anatomical features. In medical diagnostic applications, such features may include specific anatomies or regions of a patient viewable by virtue of the physics of the image acquisition modality, such as soft tissue in MRI system images, bone in X-ray images, and so forth. Each image is comprised of a matrix having a width 104 and a height 106 defined by the number and distribution of individual pixels 108. The pixels of the image matrix are arranged in rows 110 and columns 112, and will have varying characteristics which, when viewed in the reconstructed image, define the features of interest. In a typical medical diagnostic application, these characteristics will include gray level intensity or color. In the digitized data stream, each pixel is represented by binary code, with the binary code being appended to the descriptive header to aid in identification of the image and in its association with other images of a study. As noted above, such descriptive information may include industry standard information, such as DICOM compliant data.

One component of a compression scheme used in image coding systems of the type which may be used to compress and decompress image 100 is dyadic wavelet transformation (WT). In particular, dyadic wavelet transformation provides many desirable qualities such as high compression ratios, which may be achieved because WT decorrelates the image into subbands of different frequencies. Dyadic WT also provides a multi-resolution framework for representing the image with different levels of approximation and allows for either “lossy” or “lossless,” i.e., imperfect or perfect, reconstruction depending on the implementation. With dyadic WT it is possible to reconstruct an approximation of the image at dyadic resolutions, i.e., in factors of ½, from the same bitstream, a property known as embedded in resolution. Because of these various properties, dyadic WT has proven popular in industry and academia as a component of compression standards.

For example, dyadic WT is widely employed in the various medical imaging fields, due in part to the possibility of perfect reconstruction, which preserves information about miniscule or fine features of interest 102. In addition, dyadic WT allows acceptable compression of the medical image files, which are otherwise quite large, having a bit depth between 8 and 16 and typically ranging in size from 256×256 to 2000×2000 pixels with some imaging modalities generating images up to 25,000×25,000 pixels. Further, many medical imaging modalities, such as computed tomography, may obtain up to 1000 images or “slices” in an imaging sequence. The extensive number of images generated combined with the large file sizes of each image demonstrate the need for good compression with features such as embedded in resolution, as is provided by dyadic WT. In addition, because dyadic WT provides the ability to reconstruct the image at different resolutions, waiting time is reduced at the decoder, allowing the end user to assess the image without waiting for the entire bitstream to decode.

Dyadic WT does, however, have certain limitations. In particular, dyadic WT is limited in the number of different resolutions available due to the dyadic nature of the wavelet transform. Dyadic WT provides resolutions that are dyadic factors, i.e., each transformed dimension is reduced by half. The number of resolutions provided equals the number of levels of decomposition (L), such that it is possible to reconstruct a compressed two-dimensional image at resolutions of 1 (the original resolution), ½, ¼, ⅛, 1/16, . . . , (½)^{L}. For example, in the case of a 512×512 pixel image, it is possible to get approximations of the original image at 256×256, 128×128, 64×64 and so on, from the same compressed bitstream, i.e., the embedded resolutions.

This limited number of decomposition levels, or resolutions, may present problems when the display device or printer has a resolution different than the available dyadic resolutions, such as 768×768 or 1,024×768 in the case of the preceding example. One approach to addressing this problem is to increase the available levels of decomposition. However, this approach is generally unsatisfactory because, at higher levels of decomposition (½)^{L} may be very small. For example, in the case of a 512×512 pixel image, at L=5 the smallest decodable image is 16×16, which is too small for perception by the human eye. Furthermore, each dyadic decomposition reduces the number of pixels by 75%, resulting in less real information in the image after each decomposition. Instead, it would be desirable to have greater numbers of perceptible resolutions and especially finer or configurable resolutions. This would allow the reduction in information from one level to the next to be more gradual, i.e., less than 75%, and allow an image to be sent to an output device at a resolution specifically accommodated by the device, thereby optimizing output quality with bandwidth utilization required for image transmission.

Generalized Wavelet Transforms

One such technique includes the use of generalized, including non-dyadic, wavelet transforms capable of providing more perceptible embedded resolutions than dyadic WT. These generalized transforms would therefore allow the reconstruction of images at non-dyadic resolutions from the original image while still possessing the multi-resolution framework of dyadic WT. In particular, within this generalized wavelet transform framework, at any level of decomposition, any desired resolution in any data dimension can be obtained in an embedded fashion. The resolutions can be embedded in a bitstream to provide lossy (imperfect) or lossless (perfect) reconstruction. In practice, the dimensions are processed separately. For example, in a two dimensional image, each row might be processed prior to the processing of the column data.

In the following discussion of this generalized WT system, N represents the total number of data points, such as pixels in a row or a column in the case of a digital image, while n represents the number of data points, such as pixels in the case of an image, handled at one time. For example, assuming a 768×768 image, N would be 768 when processing the rows and 768 when processing the columns. The value of n, however, may be determined by an operator or an automated routine, based upon the desired result. For dyadic results, which may be reproduce by this generalized scheme, n would be set equal to two, i.e., data points would be handled in groups of 2. Non-dyadic results may be obtained by using numbers for n other than 2, such as 3 or 4, provided that the selected number of approximate coefficients, k, discussed below, does not produce a ratio of k/n equal to ½.

For example, in the case of a 768×768 pixel image and an n of 3, the 768 pixels comprising each row or each column may be processed in groups of 3, i.e., 256 groups of 3 pixels each. Similarly, an n value of 4 would result in 192 groups of 4 pixels each for processing. Note that, for simplicity, values of N and n have been provided in these examples such that N/n yields an integer. This need not be the case however. In instances where N/n does not yield an integer, padding, extension, or other techniques known in the art may be used to accommodate any discrepancies associated with the lack of even divisibility.

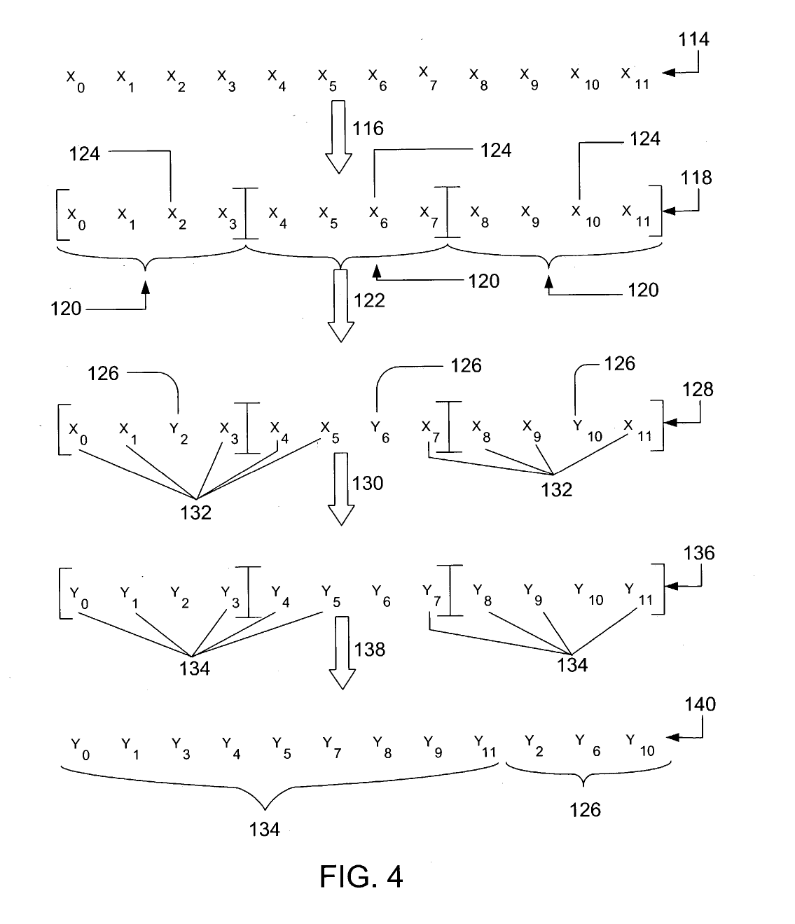

Referring now to FIG. 4, an example of a generalized forward transform is provided consisting of a set of 12 data points, here represented as pixels 108. The pixels 108 may be taken from either a row 110 or a column 112 of the respective image. The pixels 108 are initially in an original state 114 prior to compression. The pixels 108 are divided into z number of groups of n pixels each, as depicted as step 116. In the current example, if n=4, 3 groups of 4 pixels each will result such that the pixels are in a grouped state 118, with every n pixels being placed in one of z processing groups 120.

Based upon a value chosen by an operator or by an automated means, k approximate coefficients and n-k detail coefficients are calculated for each processing group 120 in one level of decomposition of a set of n data points. The k approximate coefficients constitute a lower resolution representation of the original n coefficients. The n-k detail coefficients contain the additional information needed to recreate the original n data points given the k approximate coefficients. Within this generalized framework, a dyadic transform occurs when n=2 and k=1. In a generalized implementation, however, k may be any value >0 and less than <n. The n-k detailed coefficients may be calculated by processing the selected n-k data points in each processing group 120 according to the equation:

$${Y}_{i} = {x}_{i} - {\sum }_{j = 0}^{k - 1} {β}_{j} {x}_{j} … ∀ i = k , … , ( n - 1 ) \qquad ( 1 )$$

where xᵢ represents the selected data point and Yᵢ represents the resulting coefficient, here a detailed coefficient. The values for βⱼ may be determined in various ways, depending on the desired qualities of the compressed image, such as the preservation of various moments of the signals at the lower resolution. For example, if the mean of the signal is to be preserved in the low resolution signal, the respective values βⱼ and αⱼ, discussed in greater detail below, may be cooperatively determined to preserve the mean. For example, values of βⱼ which preserve the mean of the signal, in conjunction with appropriate values of αⱼ, are given by the equation:

$${β}_{j} = \frac{1}{k} … ∀ j = 0 , … , ( k - 1 ) . \qquad ( 2 )$$

In other instances, values of βⱼ may be chosen to generate different filter or low resolution images.

The n-k selected data points may be any of the data points within the processing group 120. In one embodiment, the same respective data point, such as the first or third, is selected within each processing group 120. For example, referring once again to FIG. 4, assuming k=3, the n-k, or 1, detailed coefficient may be calculated from any of the available data points, such as pixels 108, within each processing group, as depicted by the detailed coefficient calculating step 122. In the example, the third data points in each processing group are the selected points 124, though as noted above, any n-k data points may be selected from each group 120. Each selected point 124 is processed according to equation (1) to generate the respective detailed coefficient 126, as depicted in-the detail coefficient processed data 128.

The detailed coefficients 126 may be utilized to determine the approximate coefficients associated with the remaining, non-selected points in the approximate coefficient calculating step 130. The k approximate coefficients may be calculated by processing the previously unselected and unprocessed k data points 132, in each processing group 120 according to the equation:

$${Y}_{i} = {x}_{i} + {\sum }_{j = k}^{n - 1} {α}_{j} {Y}_{j} … ∀ i = 0 , … , ( k - 1 ) \qquad ( 3 )$$

where the resulting coefficient represented by Yᵢ in this case represents an approximate coefficient. As with the values of βⱼ, the values of αⱼ may be determined in various ways depending on the desired qualities of the compressed image, such as the preservation of various moments of the signals at the lower resolution. For example, if the mean of the signal is to be preserved, αⱼ, when used in conjunction with the equation (2) giving the corresponding βⱼ, may be calculated by the following equation:

$${α}_{j} = \frac{1}{n} … ∀ j = k , … , ( n - 1 ) . \qquad ( 4 )$$

Where other image qualities are to be emphasized, however, αⱼ may be calculated differently or assigned a value which results in the desired compressed image qualities.

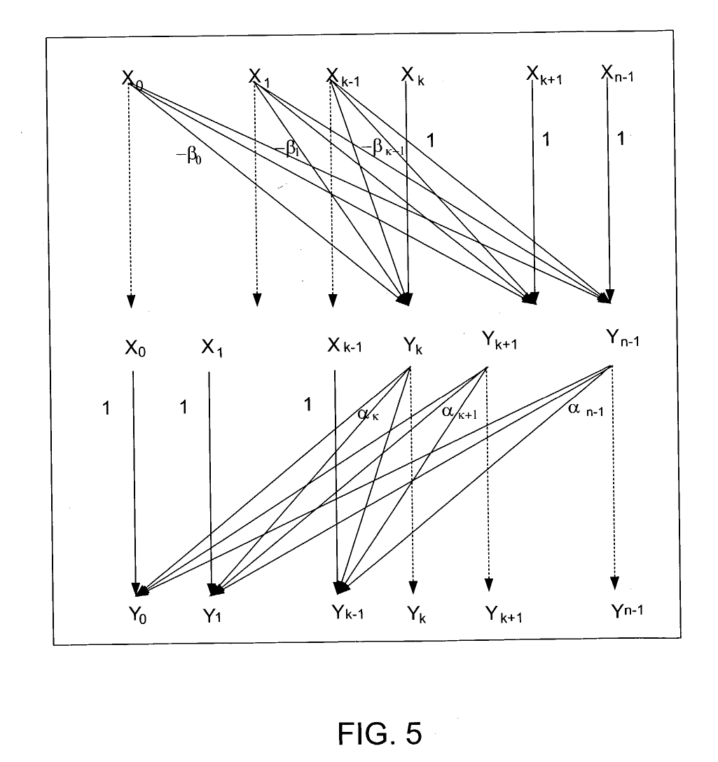

After processing of the previously unselected k data points 132, the respective approximate coefficients 134 are present in the approximate coefficient processed data 136 and the original data set 114 has undergone one level of decomposition. In particular, in the example given, the original data points 114 have undergone one level of decomposition via a non-dyadic, 3-4 (k=3, n=4), forward transform, resulting in a number of transform coefficients equal to the original number of data points, i.e., 12 in this example. The number of resulting coefficients does not have to equal the number of original data points, however. In particular, non-dyadic transforms may be employed which are redundant, in that the sum of the approximate and detailed coefficients generated from a set 120 may exceed the original number of data points in the set 120. In FIG. 5, a level of decomposition using the generalized forward transform is depicted in a more general manner.

The approximate coefficients 134 and the detailed coefficients 126 may be reorganized at step 138 after each round of decomposition to facilitate display or further decomposition. For example, referring once again to FIG. 4, the resulting approximate coefficients 134 and detailed coefficients 126 may be grouped contiguously with their order being maintained to form a reorganized processed data set 140.

Additional levels of decomposition may be achieved by applying the desired forward transform to the approximate coefficients 134 of the current level of decomposition. For example, if the same n and k are utilized for each level of decomposition, after L levels of decomposition of N data points, approximately N.(k/n)^{L} approximate coefficients will result. However, n and k need not be held constant and highly configurable levels of decomposition may be obtained by altering n and k for subsequent levels of decomposition.

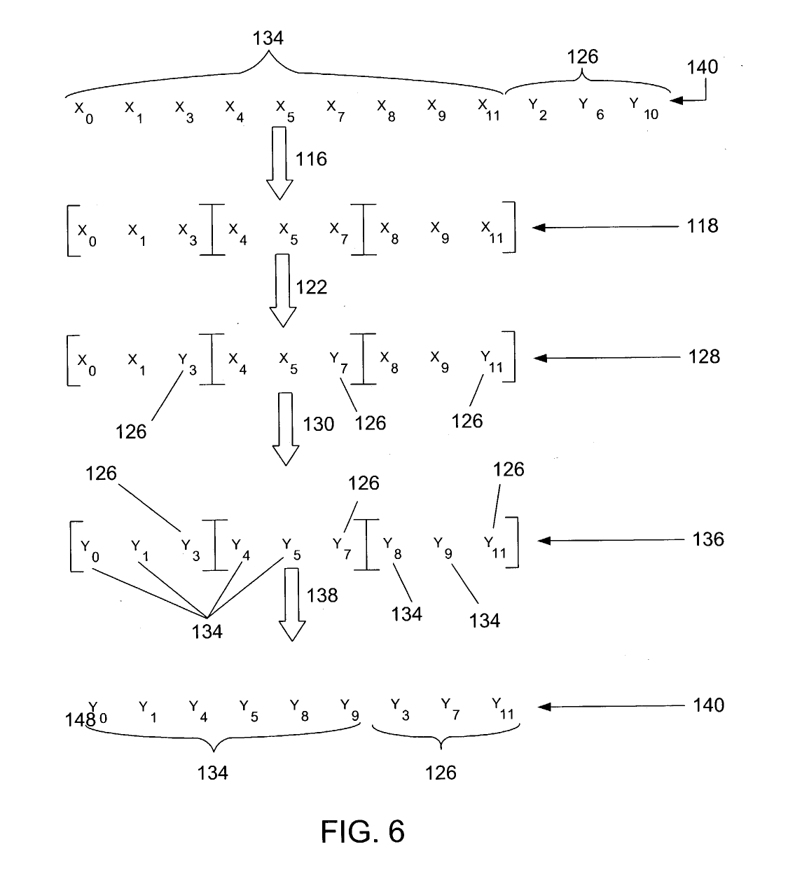

For example, referring to FIG. 6, the approximate coefficients 134 in the reorganized processed data set 140 resulting from the first level of decomposition of FIG. 4 may be further decomposed. In the subsequent decomposition, the previous approximate coefficients comprise the new initial set of data points. While the same non-dyadic 3-4 forward transform could be employed for this second level of decomposition, other values of n and k may also be employed. For example, an n of 3 and a k of 2 may be employed as depicted in FIG. 6 resulting in 6 approximate coefficients 134 and 3 detailed coefficients 126. Similarly, additional decomposition may be performed on the approximate coefficients 134 from this generalized forward transform.

It is worth noting that the cascaded application of the 3-4 forward transform of FIG. 4 and the 2-3 forward transform of FIG. 6 yields 6 approximate coefficients 134, as would result if a single dyadic forward transform where applied to the initial data set 114 of FIG. 4. In other words, consecutive application of different non-dyadic forward transforms may result in a dyadic image resolution. However, additional resolution levels are available between the original and the dyadic resolution, here the ¾ resolution of FIG. 4. Obviously other combinations of non-dyadic forward transforms may also result in dyadic resolutions. In addition, dyadic forward transforms may be preceded or followed by non-dyadic forward transforms to generate otherwise unavailable resolutions, i.e., arbitrary resolutions, of the compressed data. The ability to cascade non-dyadic and dyadic transforms as well as non-dyadic and non-dyadic transforms makes the use of these transforms highly flexible within existing compression schemes.

As noted above, in the processing of a multi-dimensional set of data points, each dimension may be processed separately. For example, the rows 110 and the columns 112 comprising the image 100 may be processed separately and generally either may be processed first. The same values of n and k may be used from processing the rows 110 and columns 112 of an image 100 or different values may be used, particularly where the image 100 is not square but is instead rectangular or where a rectangular compressed image is desired from a square original image. In addition, in digital video, a third dimension, the dimension of time, may also be present. The video may be compressed in time, in addition to the rows 110 and columns 112, using a generalized forward transform. As with the discussion of rows 110 and columns 112, the same values of n and k may be used to compress the video in the time dimension as are used in the other dimensions or different values may be employed.

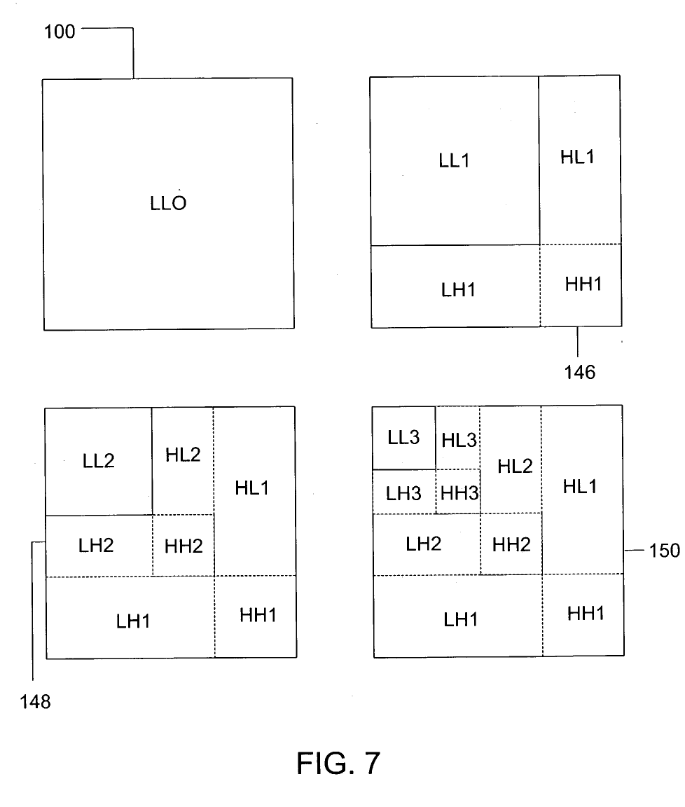

Referring now to FIG. 7, a sample of the results of the application of a generalized forward transform to a square image 100 is depicted. A non-dyadic forward transform has been applied three times and the same n and k was used for both the rows and the columns as well as for each forward transform. As noted above, however, different values of n and k may be used for the rows and columns or for subsequent forward transforms. In addition, after each forward transform, the approximate coefficients 134 and the detailed coefficients 126 have been reorganized into contiguous groups, as performed at step 138.

The letters L and H represent “low” and “high” frequency, respectively corresponding to the approximate and detailed coefficients generated by the transform processes discussed above. The first letter refers to the frequency in the horizontal direction of the image, i.e., the rows 110, and the second letter refers to the frequency in the vertical direction of the image, i.e., the columns 112. The number following the letters refers to the decomposition level such that the application of a generalized forward transform, once along a row 110 and once along a column 112 in either order, constitutes one level of decomposition. Unlike dyadic transforms, where one level of decomposition yields subbands of uniform dimensions, non-dyadic transforms, such as that employed in this example, yield subbands of different dimensions, determined by the values of n and k.

For example, referring to FIG. 7 once again, the original image 100 has not undergone a forward transform and is thus labeled LL0. After one non-dyadic forward transform however, the first decomposed image 146 is split into four subbands. The LL1 subband corresponds to the image information contained in the horizontal and vertical approximate coefficients 134. The HH 1 subband corresponds to the information contained in the horizontal and vertical detailed coefficients 126 while the LH1 and HL1 subbands correspond to respective combinations of this information. As noted above, the LL1 subband, comprising the approximate coefficients 134, may undergo a second forward transform to yield second decomposed image 148 in which LL1 has been decomposed into four respective subbands, LL2, HH2, HL2, and LH2, such that the original image 100 is split into 7 frequency subbands. The LL2 subband may also be subjected to the non-dyadic forward transform to produce the third decomposed image 150 which possess 10 frequency subbands due to the decomposition of LL2 into LL3, HH3, LH3 and HL3. In the present example, LL0, LL1, LL2, and LL3 represent different resolutions of the original image 100 which are available for viewing by an end user. That is, LL0, LL1, LL2, and LL3 comprise the respective horizontal and vertical approximate coefficients 134 of each decomposition level which contain viewable image information.

It is worth noting that each respective LL and HH subband can be used to reconstruct the LL subband of the previous decomposition level by application of the corresponding inverse transform. For example, LL3 and HH3, which contain the respective approximate coefficients 134 and detailed coefficients 126, may, by application of the corresponding inverse non-dyadic transform, be used to reconstruct LL2. Similarly LL2 and HH2 may be used to reconstruct LL1, and so forth. In this manner, the original image can be reconstructed from the various frequency subbands.

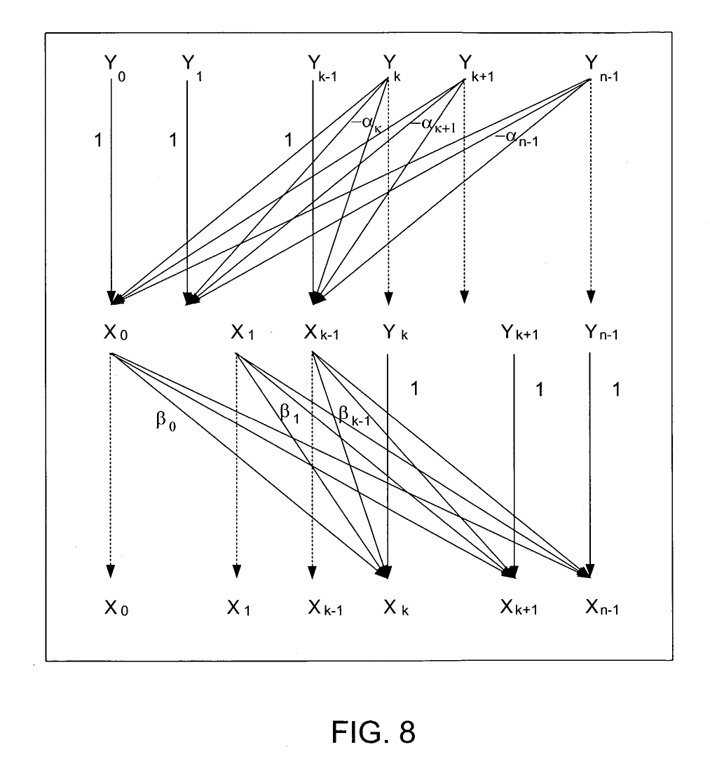

In particular, to reconstruct an image or to return to a previous level of decomposition, the inverse transform is performed by reversing the steps of the respective forward transforms. That is, the unselected data points 132 are reconstructed from the detailed coefficients 126 and the approximate coefficients 134. The selected data points 124 may then be reconstructed from the unselected data points 132 and the detailed coefficients 126. A generalized depiction of this one level of reconstruction is illustrated in FIG. 8 which depicts the inverse transform corresponding to the forward transform of FIG. 5. The respective inverse equation to reconstruct data points from approximate coefficients, i.e., the inverse transform corresponding to equation (3), may be given as:

$${x}_{i} = {Y}_{i} - {\sum }_{j = k}^{n - 1} {α}_{j} {Y}_{j} … ∀ i = 0 , … , ( k - 1 ) . \qquad ( 5 )$$

Similarly, the respective inverse equation to reconstruct data points from detailed coefficients, i.e., the inverse transform corresponding to equation (1), may be given as:

$${x}_{i} = {Y}_{i} + {\sum }_{j = 0}^{k - 1} {β}_{j} {x}_{j} … ∀ i = k , … , ( n - 1 ) . \qquad ( 6 )$$

While the above discussion pertains in general to a floating point implementation of the generalized forward transform process, an integer implementation may be similarly employed and may be implemented by lifting. The integer implementation via lifting has low computation and memory requirements and may be implemented by appropriately configured hardware, software or combinations of hardware and software. Such an integer implementation provides lossless, i.e., perfect, reconstruction, which may not be possible in the floating point implementation due to round off error.

Integer implementation of generalized wavelet transforms may be accomplished in various ways. For example, in one such integer implementation, the detailed coefficients 126 resulting from the generalized forward transform may be calculated by the following equation:

$${Y}_{i} = {x}_{i} - {\sum }_{j = 0}^{k - 1} ⌊ {β}_{j} {x}_{j} ⌋ … ∀ i = k , … , ( n - 1 ) \qquad ( 7 )$$

where └ ┘ indicates the floor operation. Similarly, the approximate coefficients 134 may be determined by the equation:

$${Y}_{i} = {x}_{i} + {\sum }_{j = k}^{n - 1} ⌊ {α}_{j} {Y}_{j} ⌋ … ∀ i = 0 , … , ( k - 1 ) . \qquad ( 8 )$$

The respective inverse transformations to reconstruct data points from approximate coefficients corresponding to the integer implementation of equation (8) may be stated as:

$${x}_{i} = {Y}_{i} - {\sum }_{j = k}^{n - 1} ⌊ {α}_{j} {x}_{j} ⌋ … ∀ i = 0 , … , ( k - 1 ) \qquad ( 9 )$$

Similarly, the respective inverse equation to reconstruct data points from detailed coefficients, i.e., the inverse transform corresponding to equation (7), may be given as:

$${x}_{i} = {Y}_{i} + {\sum }_{j = 0}^{k - 1} ⌊ {β}_{j} {x}_{j} ⌋ … ∀ i = k , … , ( n - 1 ) . \qquad ( 10 )$$

In an alternate implementation, the detailed coefficients 126 resulting from the generalized forward transform may be calculated by the following equation:

$${Y}_{i} = {x}_{i} - ⌊ {\sum }_{j = 0}^{k - 1} {β}_{j} {x}_{j} ⌋ … ∀ i = k , … , ( n - 1 ) . \qquad ( 11 )$$

The corresponding approximate coefficients 134 may be determined by the equation:

$${Y}_{i} = {x}_{i} + ⌊ {\sum }_{j = k}^{n - 1} {α}_{j} {Y}_{j} ⌋ … ∀ i = 0 , … , ( k - 1 ) . \qquad ( 12 )$$

The respective inverse transformations to reconstruct data points from approximate coefficients corresponding to the integer implementation of equation (12) may be stated as:

$${x}_{i} = {Y}_{i} - ⌊ {\sum }_{j = k}^{n - 1} {α}_{j} {Y}_{j} ⌋ … ∀ i = 0 , … , ( k - 1 ) . \qquad ( 13 )$$

Similarly, the respective inverse equation to reconstruct data points from detailed coefficients, i.e., the inverse transform corresponding to equation (11), may be given as:

$${x}_{i} = {Y}_{i} + ⌊ {\sum }_{j = 0}^{k - 1} {β}_{j} {x}_{j} ⌋ … ∀ i = k , … , ( n - 1 ) . \qquad ( 14 )$$

In view of the above discussion regarding both floating point and integer implementations, the following examples are provided for illustrative purposes. For example, for a 3-5 wavelet transform, i.e., k=3, n=5, assuming the detailed coefficients are Y₃ and Y₄, the detailed coefficients generated by the forward transform may be represented as:

Y₃=x₃−(x₀+x₁+x₂)/3, and

Y₄=x₄−(x₀+x₁+x₂)/3.

The approximate coefficients my similarly be represented as:

Y₀=x₀+(Y₃+Y₄)/5,

Y₁=x₁+(Y₃+Y₄)/5, and

Y₂=x₂+(Y₃+Y₄)/5.

The respective inverse transform of the approximate coefficients may be represented as:

x₀=Y₀−(Y₃+Y₄)/5,

x₁=Y₁−(Y₃+Y₄)/5, and

x₂=Y₂−(Y₃+Y₄)/5

while the inverse transform of the detailed coefficients may be represented as:

x₃=Y₃+(x₀+x₁+x₂)/3, and

x₄=Y₄+(x₀+x₁+x₂)/3.

Similarly, for a 3-4 wavelet transform, assuming the detailed coefficient is Y₃, the detailed coefficient may be represented as:

Y₃=x₃−(x₀+x₁+x₂)/3.

The approximate coefficients my similarly be represented as:

Y₀=x₀+(Y₃/4),

Y₁=x₁+(Y₃/4), and

Y₂=x₂+(Y₃/4).

The respective inverse transform of the approximate coefficients may be represented as:

x₀=Y₀−(Y₃/4),

x₁=Y₁−(Y₃/4), and

x₂=Y₂−(Y₃/4)

while the inverse transform of the detailed coefficients may be represented as:

x₃=Y₃+(x₀+x₁+x₂)/3.

The above examples are not intended to be exhaustive but are instead provided to illustrate the operation of the generalized WT framework, particularly the generation of non-dyadic transforms. The manner in which these various generalized transforms may be implemented in a system, such as image management system 10, will now be discussed.

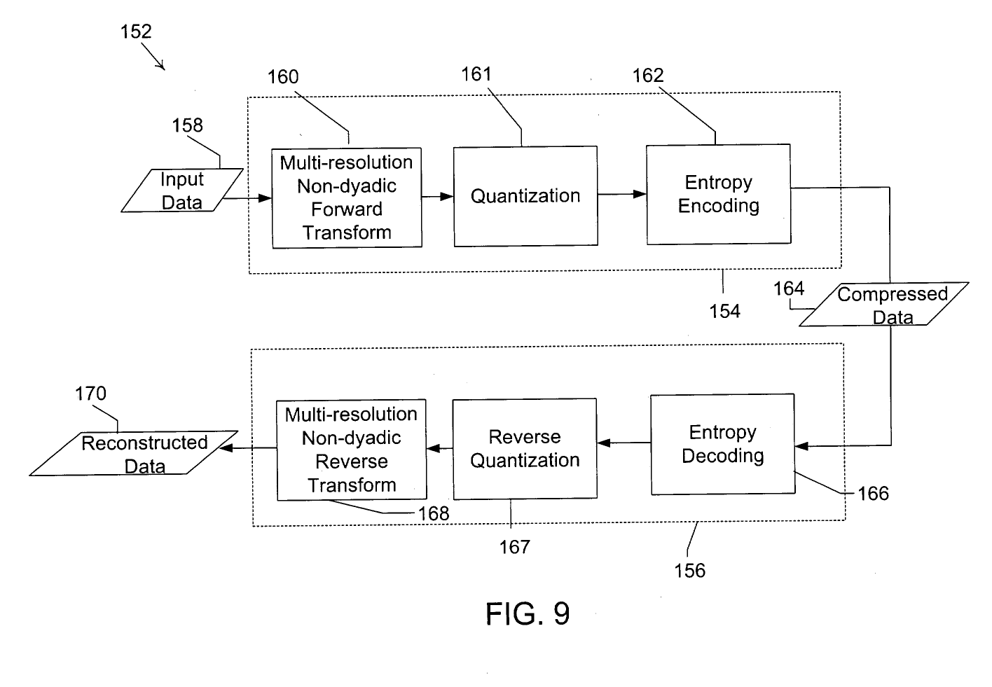

The forward and inverse transforms discussed above, either floating point or integer based, may be implemented in a system, such as the image management systems 10 through the use of a coder/decoder (codec) configured to encode and decode data streams. A generic codec 152 of this type is depicted in FIG. 9. The codec typically consists of both a coder 154 and a decoder 156, either or both of which may be present in a component of an image management system 10, such as the compression/decompression interface 20 or clients 22, or in a stand alone imaging system such as a workstation or imaging station. In particular, in a networked environment, the coder 154 and decoder 156 utilized to respectively compress and decompress an image 100 may actually reside on different components in the networked environment. In this manner, the precise amount of compressed data needed to reconstruct an image at a desired resolution may be transmitted from the coder to the decoder at a different location.

Referring once again to FIG. 9, input data 158, such as the digital image 100, is received by the coder 154 wherein a compression component 160 executes one or more generalized forward transforms upon the data 158. The compression component 160 may consist of circuitry, executable routines, or some equivalent mechanism. A quantization component 161 may be present to quantitize the resulting bitstream. In lossless implementations, the quantitization will be 1. The data may also be entropy coded by an entropy coder 162 if one is included in the coder 154. The entropy coder 162 may further compress the transformed coefficients resulting bitstream. The entropy coder 162, and the corresponding entropy decoder discussed below, may be one which is employed in other known image compression schemes such as Huffman, Arithmetic, Run-Length, etc.

The resulting compressed data 164 is transmitted to a decoder 156, either local or remote from the coder 154, for decompression. At the decoder 156 the compressed data 164 may be passed through an entropy decoder 166 if an entropy coder 162 was employed during compression. In addition, if the data was quantitized, it may undergo dequantization by a properly configured component 167 which may be present in the decoder 156. The coefficients may then be inverse transformed by a decompression component 168 of the decoder 156 which executes one or more corresponding generalized inverse transforms to generate the reconstructed data 170. The decompression component 168 may consist of circuitry, executable routines, or some combination of these mechanisms. In one embodiment, the generic codec 152 is a “lossless” or perfect reconstruction codec such that the reconstructed data 170 is a bit by bit match with the input data 158.

Specific Non-Dyadic Wavelet Transforms

While the approach discussed above may be useful for generating multi-resolution non-dyadic wavelet transforms within a generalized framework, other approaches may also be employed to generate specific non-dyadic wavelet transforms. These alternative approaches may be optimized to provided improved compressed image quality or other desirable features. As with the generalized approach, the non-dyadic transforms of the following discussion obtain a multi-resolution representation of the original signal and reconstruct the signal at non-dyadic resolutions from the same compressed bitstream in an efficient manner. The specific non-dyadic wavelet transforms may be configured for perfect or imperfect reconstruction of the original signal at the original resolution. As with the generalized approach, the non-dyadic transforms of the following discussion can be cascaded with dyadic or non-dyadic transforms to generate additional resolutions. The non-dyadic transforms may also be differentially applied to the different dimensions of the data set, i.e., rows, columns, time, to achieve the desired resolution for each dimension at a common level of decomposition.

The specific non-dyadic wavelet transforms may be constructed so that the reduction in the number of pixels from one level to the next is less than the 75% observed in dyadic wavelet transforms. This allows a greater number of visually perceptible resolutions than dyadic WT. In addition, the specific non-dyadic wavelet transforms may be easily implemented as integer implementations via lifting and are not computationally intensive.

While various non-dyadic wavelet transforms may be constructed consistent with the following discussion, two examples will be discussed in detail to illustrate the construction and use specific non-dyadic wavelet transforms. The first example reconstructs an approximation of the original image at every ⅔ resolution based upon a multi-resolution representation of the original image and will therefore be referred to as Xform-⅔. The Xform-⅔ is able to reconstruct approximations of a 512×512 pixel original image through 9 levels of decomposition, i.e., at resolutions of 342×342, 228×228, 152×152, 102×102, 68×68, 46×46, 32×32, 22×22 and 16×16. Dyadic wavelet transformation of the same image of course yields only 5 levels of decomposition from the compressed bitstream, i.e., resolutions of 256×256, 128×128, 64×64, 32×32, and 16×16. The increased number of available embedded resolutions and the flexibility associated with this increase is of course one advantage provided by specific non-dyadic wavelet transforms.

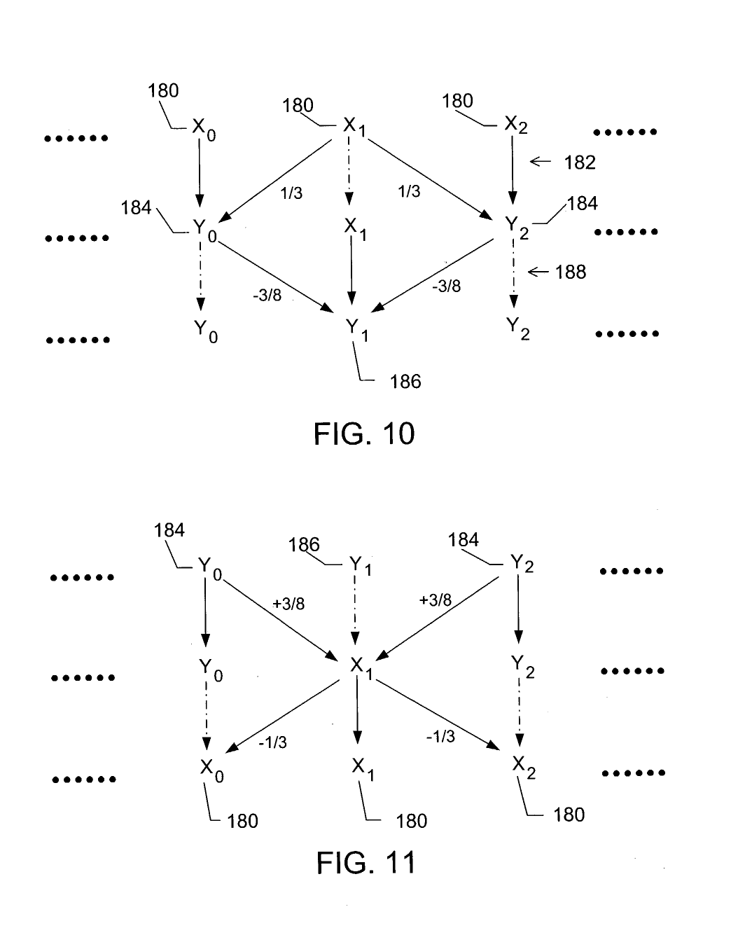

Referring now to FIG. 10, the forward Xform-⅔ transform is depicted. A subset of initial data points 180 is depicted which may comprise a portion of a row, column or other dimension of a larger data set. In an approximate coefficient computation step 182, the approximate coefficients 184 may be computed such that:

Y₀=x₀+└(x₁/3)┘ and (15)

Y₂=x₂+└(x₁/3)┘. (16)

The approximate coefficients 184 represent the low-pass components, which, in this example, represent a ⅔^{rd} resolution signal after scaling by a factor of ¾. The flooring operation is denoted by └(.)┘. The high-pass component, detailed coefficient 186, may be computed via the detailed coefficient computation step 188 such that:

Y₁=x₁−└(⅜)*(Y₀)┘−└(⅜)*(Y₂)┘. (17)

The detailed coefficient Y₁ 186 may be used to reconstruct the original data points 180 via the Xform-⅔ inverse transform depicted in FIG. 11. In particular, x₁ is calculated such that:

x₁=Y₁+└(⅜)*(Y₀)┘+└(⅜)*(Y₂)┘. (18)

The remaining original data points 180 may then be reconstructed such that:

x₀=Y₀−└(x₁/3)┘ and (19)

x₂=Y₂−└(x₁/3)┘ (20)

From the equations for the forward Xform-⅔ transform it can be seen that the Xform-⅔ forward transform performs an approximate interpolation of the 3 original signals 180, x₀, x₁, and x₂. The general form of the equations (15), (16), and (17) is given by the respective equations:

Y₀=δ*x₀+(1−δ)*x₁ (21)

Y₂=δ*x₂+(1−δ)*x₁ (22)

Y₁=x₁−λ*(Y₀)−λ*(Y₂). (23)

By choosing δ=¾ and λ=½ we obtain:

$$\begin{matrix}{Y}_{0} = {( \frac{3}{4} )}^{*} {x}_{0} + {( 1 - \frac{3}{4} )}^{*} {x}_{1} \\ = {( \frac{3}{4} )}^{*} {x}_{0} + {( \frac{1}{4} )}^{*} {x}_{1} \\ = {( \frac{3}{4} )}^{*} \{ {x}_{0} + {( )}^{*} {x}_{1} \} , \\ {Y}_{2} = {( \frac{3}{4} )}^{*} {x}_{2} + {( 1 - \frac{3}{4} )}^{*} {x}_{1} \\ = {( \frac{3}{4} )}^{*} {x}_{2} + {( \frac{1}{4} )}^{*} {x}_{1} \\ = {( \frac{3}{4} )}^{*} \{ {x}_{2} + {( )}^{*} {x}_{1} \} , and \\ {Y}_{1} = {x}_{1} - {( \frac{1}{2} )}^{*} {Y}_{0} - {( \frac{1}{2} )}^{*} {Y}_{2} .\end{matrix}$$

and

Y₁=x₁−(½)*Y₀−(½)*Y₂.

To facilitate integer-based processing, the factor of ¾ may be omitted to make Y₀ and Y₂ integers. To compensate, these coefficients may be scaled up by the ¾ factor at the decoder. In one embodiment the scale factor employed at the decoder may differ from that factor omitted at this stage in order to further improve compressed image quality. For example, a scale factor of ⅔ may instead be employed at the decoder. In addition, to account for the omission of the ¾ factor from Y₀ and Y₂, the detailed coefficient Y₁ is also adjusted to compensate such that:

Y₁=x₁−( )*Y₀−( )*Y₂.

In regard to the selection of δ and λ, the motivation for choosing δ=¾ is that x₀ is nearer to Y₀ than to x₁ and hence its contribution to Y₀ is 75%. Similar arguments hold for Y₂. Y₁ may be chosen so that it is possible to get perfect, i.e., lossless, reconstruction. Application of the Xform-⅔ transform and its respective inverse to a multi-dimensional data set or in a cascaded fashion is performed consistent with the prior discussion regarding the generalized wavelet transforms.

By means of a second example of a specific non-dyadic wavelet transform, a transform which obtains a multi-resolution representation of the initial signal at every ¾ resolutions is provided. This transform, referred to herein as the Xform-¾, provides 14 levels of decomposition of a 512×512 pixel image compared to the 5 provided by dyadic wavelet transform, i.e., 384×384, 288×288, 216×216, 162×162, 123×123, 93×93, 72×72, 54×54, 42×42, 33×33, 27×27, 21×21, 18×18, and 15×15.

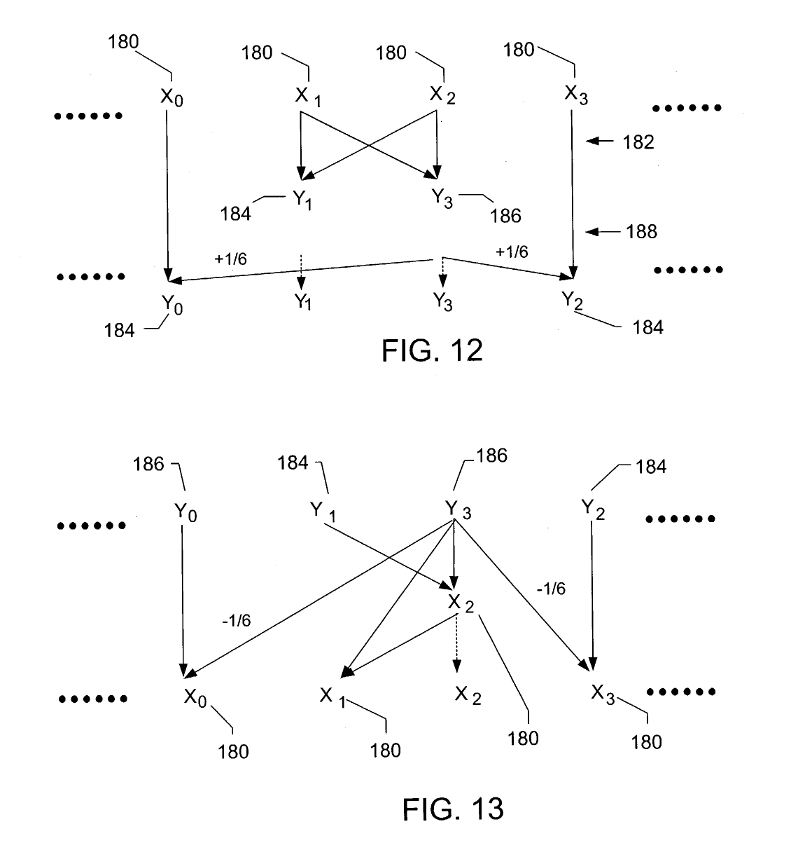

Referring now to FIG. 12, the forward Xform-¾ transform is depicted. A subset of initial data points 180 is depicted which may comprise a portion of a row, column or other dimension of a larger data set. In an approximate coefficient computation step 182, the approximate coefficients 184 may be computed such that:

Y₀=x₀+└Y₃/6┘ (24)

Y₁=└(x₁+x₂)/2┘. (25)

Y₂=x₃+└Y₃/6┘. (26)

The approximate coefficients 184 represent the low-pass components, which, in this example, represent a ¾ resolution approximation of the original signal. The high-pass component, detailed coefficient 186, may be computed via the detailed coefficient computation step 188 such that:

Y₃=x₁−x₂. (27)

In this example, the Y₁ and Y₃ coefficients are the Haar transform of x₁ and x₂ where Y₁ is the low pass coefficient and Y₃ is the high pass coefficient. Y₀ and Y₂ include a correction factor, └Y₃/6┘, which is equivalent to └(x₁−x₂)/6┘. Y₁ contains the low pass information of x₁ and X₂.

The detailed coefficient Y₃ 186 may be used to reconstruct the original data points 180 via the Xform-¾ inverse transform depicted in FIG. 13. In particular, x₂ is calculated such that:

x₂=Y₁−└(Y₃+1)/2┘. (28)

The remaining original data points 180 may then be reconstructed such that:

x₁=Y₃+x₂ (29)

x₀=Y₀−└Y₃/6┘ (30)

x₃=Y₂−└Y₃/6┘. (31)

Unlike the Xform-⅔, no scaling is required here. As with the Xform-⅔ the Xform-¾ may be applied in a cascaded manner or differentially between data set dimensions in a manner similar to that discussed above for the generalized wavelet transform model.

The examples of specific non-dyadic wavelet transform provided above, i.e., the Xform-⅔ and the Xform-¾, while not exhaustive of this type of non-dyadic transform, are intended to illustrate the construction and use of such transforms. Various other non-dyadic transforms of this type, which do not fit the generalized wavelet transform model discussed previously, may be fashioned in accordance with these examples. As with the generalized transforms discussed above, the specific non-dyadic transforms may be implemented by a generic codec, of the type depicted in FIG. 9 and discussed in relation to FIG. 9.

Both the generalized and specific transform techniques discussed above are of similar complexity to existing dyadic compression schemes and may therefore be implemented on existing image management systems. In addition, due to the arbitrary levels of resolution provided by both the generalized and specific transform techniques, these techniques are well suited for use over networks, whether internets or intranets, where bandwidth may be limited and it is desirable to transmit compressed images in accordance with the resolution of the target display device. In the context of medical imaging, the generalized and specific transform techniques may be useful in the tele-radiology context where network bandwidth constraints may be stringent. However any context in which the transmission of compressed video or images occurs over limited bandwidth may benefit from the techniques described above.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for compressing a set of data points comprising:
grouping a plurality of data points into one or more subgroups;
calculating one or more first coefficients for each subgroup wherein each first coefficient is calculated using one or more data points within the respective subgroup; and
calculating one or more second coefficients for each subgroup wherein each second coefficient is calculated using at least one of one or more first coefficients and one or more data points within the respective subgroup and wherein the number of first coefficients does not equal the number of second coefficients.

2. The method as recited in claim 1, wherein the first coefficients are detailed coefficients and the second coefficients are approximate coefficients.

3. The method as recited in claim 1, wherein the first coefficients are approximate coefficients and the second coefficients are detailed coefficients.

4. The method as recited in claim 1, wherein the plurality of data points is one of a digital image and a digital video.

5. The method as recited in claim 1, further comprising reorganizing the first coefficients such that the first coefficients are sequential and contiguous.

6. The method as recited in claim 1, further comprising reorganizing the second coefficients such that the second coefficients are sequential and contiguous.

7. A codec for compressing and decompressing digital data, the codec comprising:
a coder configured to group a plurality of data points comprising a digital record into one or more subgroups, to calculate one or more first coefficients for each subgroup wherein each first coefficient is calculated using two or more data points within the respective subgroup, and to calculate one or more second coefficients for each subgroup wherein each second coefficient is calculated using at least one of one or more first coefficients and one or more data points within the respective subgroup and wherein the number of first coefficients does not equal the number of second coefficients; and
a decoder configured to reconstruct the plurality of data points from the first coefficients and the second coefficients.

8. The codec as recited in claim 7, wherein the first coefficients are detailed coefficients and the second coefficients are approximate coefficients.

9. The codec as recited in claim 7, wherein the first coefficients are approximate coefficients and the second coefficients are detailed coefficients.

10. The codec as recited in claim 7, wherein the coder is further configured to reorganize the first coefficients such that the first coefficients are sequential and contiguous.

11. The codec as recited in claim 7, wherein the coder is further configured to reorganize the second coefficients such that the second coefficients are sequential and contiguous.

12. The codec as recited in claim 7, wherein the coder further comprises at least one of a quantitizing component and an entropy encoding component and wherein the decoder comprises at least one of a reverse quantitizing component and an entropy decoding component.

13. An image management system, the system comprising:
one or more file servers configured to receive one or more data files from and to transmit one or more data files to at least one of one or more input/output interface, one or more imaging systems, one or more image storage systems, and one or more remote clients; and
a codec configured to process the data files, the codec comprising:
a coder configured to group a plurality of data points comprising a digital record into one or more subgroups, to calculate one or more first coefficients for each subgroup wherein each first coefficient is calculated using two or more data points within the respective subgroup, and to calculate one or more second coefficients for each subgroup wherein each second coefficient is calculated using at least one of one or more first coefficients and one or more data points within the respective subgroup and wherein the number of first coefficients does not equal the number of second coefficients; and
a decoder configured to reconstruct the plurality of data points from the first coefficients and the second coefficients.

14. The image management system as recited in claim 13, wherein the coder and the decoder are both located on one of the file servers, the one or more input/output interfaces, the one or more imaging systems, the one or more image storage systems, and the one or more remote clients.

15. The image management system as recited in claim 13, wherein the coder and the decoder are remote from one another.

16. The image management system as recited in claim 13, wherein the first coefficients are detailed coefficients and the second coefficients are approximate coefficients.

17. The image management system as recited in claim 13, wherein the first coefficients are approximate coefficients and the second coefficients are detailed coefficients.

18. The image management system as recited in claim 13, wherein the coder is further configured to reorganize the first coefficients such that the first coefficients are sequential and contiguous.

19. The image management system as recited in claim 13, wherein the coder is further configured to reorganize the second coefficients such that the second coefficients are sequential and contiguous.

20. A tangible medium for compressing a set of data points, the tangible medium comprising:
a routine for grouping a plurality of data points into one or more subgroups;
a routine for calculating one or more first coefficients for each subgroup wherein each first coefficient is calculated using two or more data points within the respective subgroup; and
a routine for calculating one or more second coefficients for each subgroup wherein each second coefficient is calculated using at least one of one or more first coefficients and one or more data points within the respective subgroup and wherein the number of first coefficients does not equal the number of second coefficients.

21. The tangible medium as recited in claim 20, wherein the first coefficients are detailed coefficients and the second coefficients are approximate coefficients.

22. The tangible medium as recited in claim 20, wherein the first coefficients are approximate coefficients and the second coefficients are detailed coefficients.

23. The tangible medium as recited in claim 20, further comprising a routine for reorganizing the first coefficients such that the first coefficients are sequential and contiguous.

24. The tangible medium as recited in claim 20, further comprising a routine for reorganizing the second coefficients such that the second coefficients are sequential and contiguous.

25. A method for compressing a set of data points comprising:
accessing a set of data points; and
applying a non-dyadic wavelet transform to the set of data points such that a first set of transformed data and a second set of transformed data result.

26. The method as recited in claim 25, wherein the set of data points comprise one of a digital image and a digital video.

27. The method as recited in claim 25, wherein the first set of transformed data comprises a set of one or more approximate coefficients and the second set of transformed data comprises a set of one or more detailed coefficients.

28. The method as recited in claim 27, further comprising reorganizing the one or more approximate coefficients such that the one or more approximate coefficients are sequential and contiguous.

29. The method as recited in claim 28, further comprising displaying the one or more approximate coefficients.

30. The method as recited in claim 25, further comprising applying a second non-dyadic wavelet transform to one of the first set of transformed data and the second set of transformed data.

31. The method as recited in claim 30, wherein the second non-dyadic wavelet transform is the same as the non-dyadic wavelet transform.

32. A codec for compressing and decompressing digital data, the codec comprising:
a coder configured to access a set of data points and to apply a non-dyadic wavelet transform to the set of data points such that a first set of transformed data and a second set of transformed data result.; and
a decoder configured to apply an inverse non-dyadic wavelet transform to the first set of transformed data and the second set of transformed data such that the set of data points is reconstructed.

33. The codec as recited in claim 32, wherein the first set of transformed data comprises a set of one or more approximate coefficients and the second set of transformed data comprises a set of one or more detailed coefficients.

34. The codec as recited in claim 33, wherein the coder is further configured to reorganize the approximate coefficients such that the approximate coefficients are sequential and contiguous.

35. The codec as recited in claim 32, wherein the coder further comprises at least one of a quantitizing component and an entropy encoding component and wherein the decoder comprises at least one of a reverse quantitizing component and an entropy decoding component.

36. An image management system, the system comprising:
one or more file servers configured to receive one or more data files from and to transmit one or more data files to at least one of one or more input/output interface, one or more imaging systems, one or more image storage systems, and one or more remote clients; and
a codec configured to process the data files, the codec comprising:
a coder configured to access a set of data points and to apply a non-dyadic wavelet transform to the set of data points such that a first set of transformed data and a second set of transformed data result; and
a decoder configured to apply an inverse non-dyadic wavelet transform to the first set of transformed data and the second set of transformed data such that the set of data points is reconstructed.

37. The image management system as recited in claim 36, wherein the coder and the decoder are both located on one of the file servers, the one or more input/output interfaces, the one or more imaging systems, the one or more image storage systems, and the one or more remote clients.

38. The image management system as recited in claim 36, wherein the coder and the decoder are remote from one another.

39. The image management system as recited in claim 36, wherein the first set of transformed data comprises a set of one or more approximate coefficients and the second set of transformed data comprises a set of one or more detailed coefficients.

40. The image management system as recited in claim 39, wherein the coder is further configured to reorganize the approximate coefficients such that the approximate coefficients are sequential and contiguous.

41. An image management system, the system comprising:
one or more file servers configured to receive one or more data files from and to transmit one or more data files to at least one of one or more input/output interface, one or more imaging systems, one or more image storage systems, and one or more remote clients; and
means for performing one or more non-dyadic transformations on the data files.

42. A tangible medium for compressing a set of data points, the tangible medium comprising:
a routine for accessing a set of data points; and
a routine for applying a non-dyadic wavelet transform to the set of data points such that a first set of transformed data and a second set of transformed data result.

43. The tangible medium as recited in claim 42, wherein the set of data points comprise one of a digital image and a digital video.

44. The tangible medium as recited in claim 42, wherein the first set of transformed data comprises a set of one or more approximate coefficients and the second set of transformed data comprises a set of one or more detailed coefficients.

45. The tangible medium as recited in claim 44, further comprising a routine for reorganizing the one or more approximate coefficients such that the one or more approximate coefficients are sequential and contiguous.

46. The tangible medium as recited in claim 45, further comprising a routine for displaying the one or more approximate coefficients.

47. The tangible medium as recited in claim 42, further comprising a routine for applying a second non-dyadic wavelet transform to one of the first set of transformed data and the second set of transformed data.

48. The tangible medium as recited in claim 47, wherein the second non-dyadic wavelet transform is the same as the non-dyadic wavelet transform.

49. A method for decompressing a set of data points comprising:
accessing a first set of transformed data points and a second set of transformed data points; and
applying an inverse non-dyadic wavelet transform to the first set of transformed data points and the second set of transformed data points such that an untransformed set of data points results.
